(19) United States
(12) Patent Application Publication
(10) Pub. No.: US 2020/0013321 A1
(43) Pub. Date: Jan. 9, 2020

(54) DISPLAY DEVICE AND METHOD FOR DETECTING STATE THEREOF

(71) Applicant: SHARP KABUSHIKI KAISHA, Sakai City (JP)

(72) Inventor: MASAHIRO IMAI, Sakai City (JP)

(21) Appl. No.: 16/503,217

(22) Filed: Jul. 3, 2019

Related U.S. Application Data
(60) Provisional application No. 62/695,343, filed on Jul. 9, 2018.

(51) Int. Cl. G09G 3/00; G02F 1/1333; G02F 1/1362; G09G 3/36

(52) U.S. Cl. CPC G09G 3/006; G02F 1/133305; G09G 2330/021; G09G 3/3696; G02F 1/136286

(57) ABSTRACT

A display device includes a display panel, a connecting section for electrically connecting the display panel with an external equipment, and a drive circuit mounted on the display panel or the connecting section and for outputting an internal signal as a state signal, and is configured to make the state signal propagate to the external equipment via the connecting section. The drive circuit outputs, as the state signal, an output signal of a power supply circuit included in the drive circuit, or a signal applied to an output terminal connected to a data line of the display panel or a wiring electrically connected to a scanning line drive circuit formed on the display panel. With this, a display device capable of easily detecting an abnormality which occurs in the drive circuit is provided.

### CROSS-REFERENCE TO RELATED APPLICATION

This application claims the benefit of U.S. Provisional Patent Application No. 62/695,343 filed on Jul. 9, 2018, and entitled “Display Device And Method For Detecting State Thereof”, which is incorporated herein by reference in its entirety.

### BACKGROUND OF THE INVENTION

### Field of the Invention

The present invention relates to a display device, such as a liquid crystal display device, and a method for detecting a state of the display device.

### Description of Related Art

A liquid crystal display device is widely used as a thin, light-weight, and low-power consumption display device. The liquid crystal display device is used being connected to a video signal source during normal operation. The liquid crystal panel and the video signal source are electrically connected using a flexible printed circuit (hereinafter referred to as FPC), for example. The video signal source supplies a power supply voltage, a control signal, and a video signal to the liquid crystal display device.

In the liquid crystal display device, a drive circuit which operates based on the power supply voltage, the control signal, and the video signal supplied from the video signal source may be mounted on the liquid crystal panel. In place of this, the drive circuit may be mounted on the FPC. The former mounting method is called COG (Chip On Glass), and the latter mounting method is called COF (Chip On Film).

Related to the invention of the present, application, Japanese Laid-Open Patent Publication No. 2002-365660 discloses a liquid crystal display device having, in a neighborhood of an output terminal group of a source driver IC chip, an additional output terminal connected through a switching means for selecting one arbitrary output from the output terminal group of the source driver IC chip, and a test electrode pad to which the additional output terminal is connected.

In the liquid crystal display device, an abnormality may occur in the drive circuit, mounted on the liquid crystal panel or the FPC. When the abnormality occurs in the drive circuit, a display screen may become abnormal or a power supply current may become abnormal. When the display screen or the power supply current become abnormal, an occurrence of the abnormality can be detected easily. However, in a conventional liquid crystal display device, when the abnormality occurs in the drive circuit, the occurrence of the abnormality cannot be detected easily in some cases, because an internal state of the drive circuit cannot be known from an outside.

### SUMMARY OF THE INVENTION

Therefore, providing a display device and a method for detecting a state of the display device capable of easily detecting an abnormality which occurs in a drive circuit is taken as a problem.

(1) A display device according to some embodiments of the present invention includes: a display panel; a connecting section configured to electrically connect the display panel with an external equipment; and a drive circuit mounted on the display panel or the connecting section and configured to output an internal signal as a state signal, and the state signal propagates to the external equipment via the connecting section.

(2) The display device according to some embodiments of the present invention has the configuration of above (1), and the drive circuit includes a power supply circuit and is configured to output an output signal of the power supply circuit as the state signal.

(3) The display device according to some embodiments of the present invention has the configuration of above (2), the power supply circuit includes a regulator, and the drive circuit is configured to output an output signal of the regulator as the state signal.

(4) The display device according to some embodiments of the present invention has the configuration of above (1), and the drive circuit includes an output terminal connected to a wiring of the display panel and is configured to output, as the state signal, a signal applied to the output terminal.

(5) The display device according to some embodiments of the present invention has the configuration of above (4), the display panel includes data lines, and the drive circuit includes a data line drive circuit configured to drive the data lines and is configured to output, as the state signal, a signal applied to an output terminal electrically connected to the data line.

(6) The display device according to some embodiments of the present invention has the configuration of above (4), the display panel includes scanning lines and a scanning line drive circuit, configured to drive the scanning lines, and the drive circuit is configured to output, as the state signal, a signal applied to an output terminal electrically connected to the scanning line drive circuit.

(7) The display device according to some embodiments of the present invention has the configuration of above (1), and the drive circuit is configured not to output the state signal during normal operation, and is configured to output the state signal during testing.

(8) The display device according to some embodiments of the present invention has the configuration of above (7), and the drive circuit includes a terminal configured to function as an output terminal of the state signal during testing and function as an input terminal or an output terminal of another signal during normal operation.

(9) The display device according to some embodiments of the present invention has the configuration of above (1), and the drive circuit includes a switch configured to select a signal to be output as the state signal from a plurality of internal signals.

(10) The display device according to some embodiments of the present invention has the configuration of above (1), the connecting section includes a film substrate, and the drive circuit is mounted on the film substrate.

(11) A method for detecting a state according to some embodiments of the present invention is a method for detecting a state of a display device including a display panel, a connecting section that electrically connects the display panel with an external equipment., and a drive circuit mounted on the display panel or the connecting section, and includes: outputting an internal signal of the drive circuit, as a state signal to an outside of the drive circuit; and making the state signal propagate to the external equipment via the connecting section.

(12) The method for detecting the state according to some embodiments of the present invention has the configuration of above (11), the drive circuit includes a power supply circuit, and in outputting, an output signal of the power supply circuit is output as the state signal.

(13) The method for detecting the state according to some embodiments of the present invention has the configuration of above (12), the power supply circuit includes a regulator, and in outputting, an output signal of the regulator is output as the state signal.

(14) The method for detecting the state according to some embodiments of the present invention has the configuration of above (11), the drive circuit includes an output terminal connected to a wiring of the display panel, and in outputting, a signal applied to the output terminal is output as the state signal.

(15) The method for detecting the state according to some embodiments of the present invention has the configuration of above (14), the display panel includes data lines, the drive circuit includes a data line drive circuit that drives the data lines, and in outputting, a signal applied to an output terminal electrically connected to the data line is output as the state signal.

(16) The method for detecting the state according to some embodiments of the present invention has the configuration of above (14), the display panel includes scanning lines and a scanning line drive circuit that drives the scanning lines, and in outputting, a signal applied to an output terminal electrically connected to the scanning line drive circuit is output as the state signal.

(17) The method for detecting the state according to some embodiments of the present invention has the configuration of above (11), and in outputting, the state signal is not output during normal operation, and the state signal is output during testing.

(18) The method for detecting the state according to some embodiments of the present invention has the configuration of above (17), and the drive circuit includes a terminal that functions as an output terminal of the state signal during testing arid functions as an input terminal or an output terminal of another signal during normal operation.

(19) The method for detecting the state according to some embodiments of the present invention has the configuration of above (11), and the drive circuit includes a switch that selects a signal to be output as the state signal from a plurality of internal signals.

(20) The method for detecting the state according to some embodiments of the present invention has the configuration of above (11), the connecting section includes a film substrate, and the drive circuit is mounted on the film substrate.

According to the above display device and the method for detecting the state of the display device, the internal signal of the drive circuit mounted on the display panel or the connecting section is output as the state signal, and the state signal propagates to the external equipment via the connecting section. Therefore, an abnormality which occurs in the drive circuit can be easily detected with the external equipment.

These and other objects, features, modes and effects of the present invention will be more apparent, from the following detailed description with reference to the attached drawings.

### BRIEF DESCRIPTION OF THE DRAWINGS

FIG. 1 is a block diagram showing a configuration of a liquid crystal display device according to a first embodiment.

FIG. 2 is a block diagram showing a detailed configuration of a drive circuit of the liquid crystal display device shown in FIG. 1.

FIG. 3 is a circuit diagram of a part of the drive circuit shown in FIG. 2.

FIG. 4 is a diagram showing a connection style of the liquid crystal display device shown in FIG. 1 during testing.

FIG. 5 is a circuit diagram of a charge pump circuit of the liquid crystal display device shown in FIG. 1.

FIG. 5C is a diagram showing a connection style of a liquid crystal display device according to a second embodiment during testing.

### DETAILED DESCRIPTION OF THE INVENTION

### First Embodiment

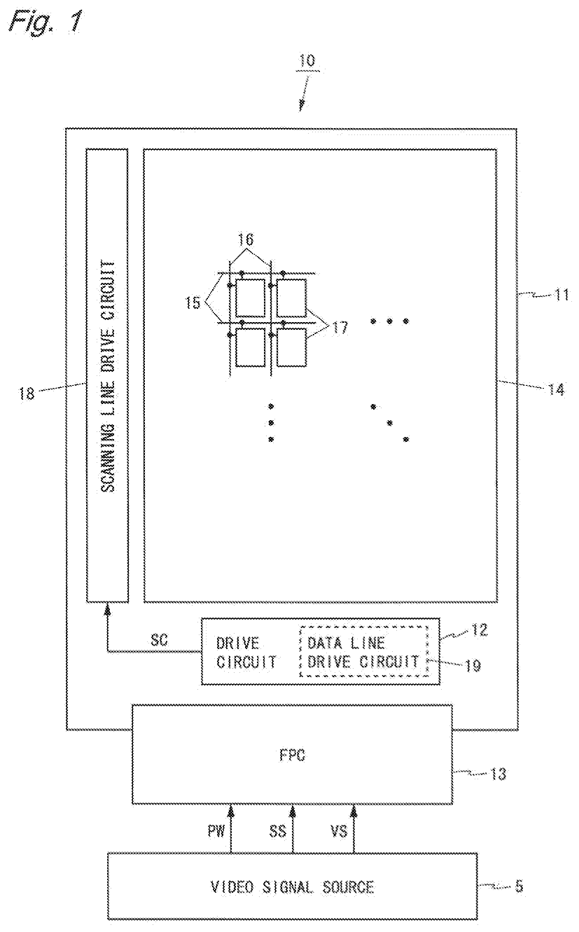

FIG. 1 is a block diagram showing a configuration of a liquid crystal display device according to a first, embodiment. A liquid crystal display device 10 shown in FIG. 1 includes a liquid crystal panel 11, a drive circuit. 12, and an FPC 13. The drive circuit 12 is mounted on the liquid crystal panel 11. The liquid crystal display device 10 is connected to a video signal source 5 during normal operation. The liquid crystal panel 11 and the video signal source 5 are electrically connected using the FPC 13. The video signal source 5 supplies a power supply voltage PW, a synchronization signal SS, and a video signal VS to the liquid crystal panel 11 via the FPC 13. The FPC 13 functions as a connecting section for electrically connecting the liquid crystal panel 11 with the video signal source 5. The liquid crystal panel 11 includes a display section 14. The display section 14 includes scanning lines 15, data lines 16, and pixel circuits 17. In the liquid crystal display device 10, a scanning line drive circuit 18 is formed on the liquid crystal panel 11 monolithically with the pixel circuits 17, and a data line drive circuit 19 is included in the drive circuit 12. The scanning line drive circuit 18 drives the scanning lines 15, and the data line drive circuit 19 drives the data lines 16. The drive circuit 12 outputs a scanning control signal SC to the scanning line drive circuit 18 based on the power supply voltage PW, the synchronization signal SS, and the video signal VS supplied from the video signal source 5, and drives the data lines 16.

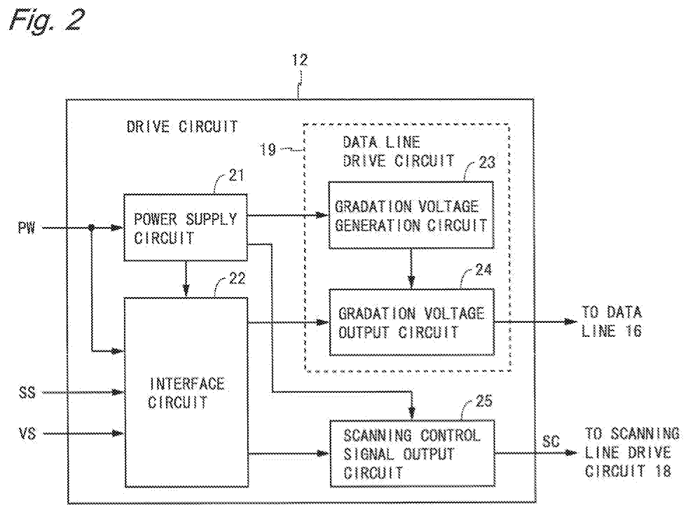

FIG. 2 is a block diagram showing a detailed configuration of the drive circuit 12. As shown in Fly. 2, the drive circuit 12 includes a power supply circuit 21, an interface circuit 22, a gradation voltage generation circuit. 23, a gradation voltage output circuit 24, and a scanning control signal output circuit 25. The gradation voltage generation circuit 23 and the gradation voltage output circuit 24 function as the data line drive circuit 19.

Based on the power supply voltage PW, the power supply circuit 21 generates voltages required in the liquid crystal panel 11 and the drive circuit 12. The interface circuit 22 receives the video signal VS in accordance with the synchronization signal SS. Based on the voltages generated in the power supply circuit 21, the gradation voltage generation circuit 23 generates gradation voltages to be applied to the data lines 16. The gradation voltage output circuit 24 applies, to the data lines 16, the gradation voltages in accordance with the video signal VS received by the interface circuit 22. The gradation voltage output circuit 24 applies either a positive gradation voltage or a negative gradation voltage to the data lines 16. For example, the positive gradation voltage is a voltage in a range of 0 V to +5 V, and the negative gradation voltage is a voltage in a range of −5 V to 0 V. The scanning control signal output circuit 25 outputs the scanning control signal SC to the scanning line drive circuit 18.

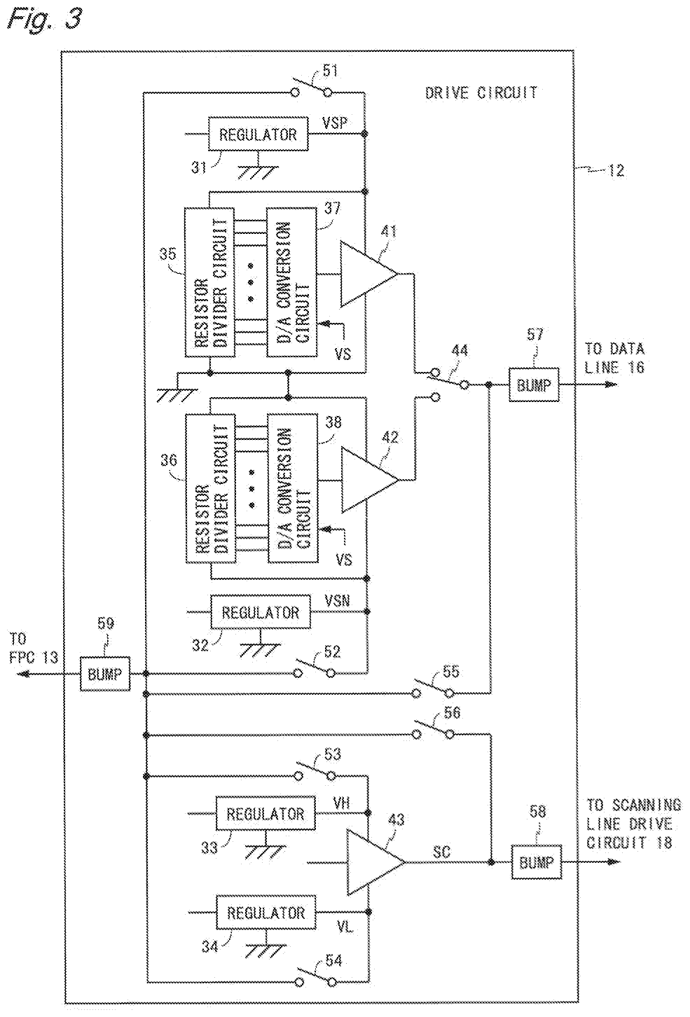

FIG. 3 is a diagram of a part of the drive circuit 12. FIG. 3 describes the power supply circuit 21, a part of the gradation voltage generation circuit 23, the gradation voltage output circuit 24, and the scanning control signal output circuit 25, and switches for outputting an internal state of the drive circuit 12 to an outside. A circuit shown in FIG. 3 includes regulators 31 to 34, resistor voltage divider circuits 35, 36, D/A conversion circuits 37, 38, output amplifiers 41 to 43, switches 44, 51 to 56, and bumps 57 to 59. The regulators 31 to 34 are provided in an output, stage of the power supply circuit 21. The resistor voltage divider circuits 35, 36 are included in the gradation voltage generation circuit 23. The D/A conversion circuits 37, 38, the output amplifiers 41, 42, and the switch 44 are included in the gradation voltage output circuit 24. The output amplifier 43 is included in the scanning control signal output circuit 25.

The regulator 31 outputs a positive reference voltage VSP, and the regulator 32 outputs a negative reference voltage VSN. Each of the resistor voltage divider circuits 35, 36 includes resistors connected in series. The positive reference voltage VSP output from the regulator 31 is applied to one end (upper end in FIG. 3) of the resistor voltage divider circuit 35, and the negative reference voltage VSN output from the regulator 32 is applied to one end (lower end in FIG. 3) of the resistor voltage divider circuit 36. The other ends of the resistor voltage divider circuits 35, 36 are grounded. The resistor voltage divider circuit 35 outputs positive gradation voltages between the positive reference voltage VSP and a ground voltage GND. The resistor voltage divider circuit 36 outputs negative gradation voltages between the negative reference voltage VSN and the ground voltage GND. The D/A conversion circuit 37 selects a voltage in accordance with the video signal VS from the positive gradation voltages output from the resistor voltage divider circuit 35. The D/A conversion circuit 38 selects a voltage in accordance with the video signal VS from the negative gradation voltages output from the resistor voltage divider circuit 36.

The positive reference voltage VSP output from the regulator 31 and the ground voltage GND are supplied to the output amplifier 41 as power supply voltages. A voltage selected by the D/A conversion circuit 37 is supplied to an input terminal of the output amplifier 41. The output amplifier 41 performs an impedance conversion on the voltage selected by the D/A conversion circuit 37. The negative reference voltage VSN output from the regulator 32 and the ground voltage GND are supplied to the output amplifier 42 as power supply voltages. A voltage selected by the D/A conversion circuit 38 is supplied to an input terminal of the output amplifier 42. The output amplifier 42 performs the impedance conversion on the voltage selected by the D/A conversion circuit 38.

An output voltage of the output amplifier 41 is supplied to a first terminal (upper-left terminal in FIG. 3) of the switch 44. An output voltage of the output amplifier 42 is supplied to a second terminal (lower-left, terminal in FIG. 3) of the switch 44. A third terminal of the switch 44 is connected to the bump 57. A polarity selection signal not shown is supplied to a control terminal of the switch 44. The bump 57 is electrically connected to the data line 16 via a wiring (not shown) formed on the liquid crystal panel 11. The switch 44 connects one of the first and second terminals to the third terminal in accordance with the polarity selection signal. With this, one of the positive gradation voltage (output voltage of the output amplifier 41) in accordance with the video signal VS and the negative gradation voltage (output voltage of the output amplifier 42) in accordance with the video signal VS is applied to the data line 16.

The regulator 33 outputs a high-level voltage VH of the scanning control signal SC. The regulator 34 outputs a low-level voltage VL of the scanning control signal SC. The high-level voltage VH output from the regulator 33 and the low-level voltage VL output from the regulator 34 are supplied to the output amplifier 43 as power supply voltages. A control signal which is a base of the scanning control signal SC is supplied to an input terminal of the output amplifier 43. The output amplifier 43 performs the impedance conversion on the control signal supplied to the input terminal and outputs the scanning control signal SC. An output terminal of the output amplifier 43 is connected to the bump 58. The bump 58 is electrically connected to the scanning line drive circuit 18 via a wiring formed on the liquid crystal panel 11. With this, the scanning control signal SC having the high-level voltage VH or the low level voltage VL is supplied to the scanning line drive circuit 18.

Note that each of the output amplifiers 41, 42 does not have a desired output characteristic in a range near the ground voltage GND (for example, in a range of −0.3 V to 0.3 V). Thus, for example, when the gradation voltage generation circuit 23 generates gradation voltages of −5 V to −5 V, the positive reference voltage VSP is set to a voltage in a range of 5.3 V to 5.5 V, and the negative reference voltage VSN is set to a voltage in a range of −5.5 V-−5.3 V.

One ends (left ends in FIG. 3) of the switches 51 to 56 are connected to the bump 59. The bump 59 is electrically connected to a terminal of the FPC 13 via a wiring formed on the liquid crystal panel 11. The other ends of the switches 51 to 54 are connected to output terminals of the regulators 31 to 34, respectively. The other end of the switch 55 is connected to a third terminal of the switch 44. The other end of the switch 56 is connected to the output terminal of the output amplifier 43. A switch control signal not shown is supplied to control terminals of the switches 51 to 56. The switches 51 to 56 all turn off in accordance with the switch control signal during normal operation. The bump 59 functions as an output terminal of a state signal ST. Note that it is desirable that the bump 59 be a terminal which functions as an output terminal of the state signal ST during testing and functions as an input terminal or an output terminal of another signal during normal operation.

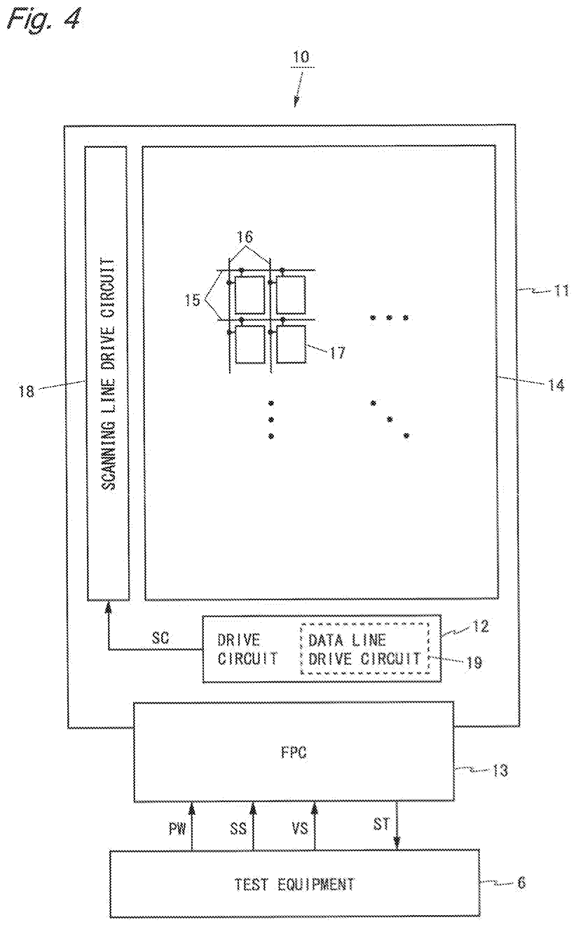

FIG. 4 is a diagram showing a connection style of the liquid crystal display device 10 during testing. As shown in FIG. 4, in place of the video signal source 5, a test equipment 6 is connected to the liquid crystal display device 10 during testing. In this case, the FPC 13 functions as a connecting section for electrically connecting the liquid crystal panel 11 with the test equipment 6. The test equipment 6 outputs the switch control signal to be supplied to the control terminals of the switches 51 to 56. The switches 51 to 56 turn on selectively in accordance with the switch control signal during testing. With this, the drive circuit 12 outputs, as the state signal ST, a signal selected from output signals of the regulators 31 to 34, a signal applied to the data line 16 (signal output via the bump 57), and the scanning control signal SC output to the scanning line drive circuit 18 (signal output via the bump 58). The state signal ST propagates to the test equipment 6 via the FPC 13.

FIG. 2 describes that the drive circuit 12 includes the whole of the power supply circuit 21. However, a part of the power supply circuit 21 may be provided outside the drive circuit 12. For example, the regulators 31, 32 may be included in the drive circuit 12 mounted on the liquid crystal panel 11, or may be provided outside the liquid crystal panel 11.

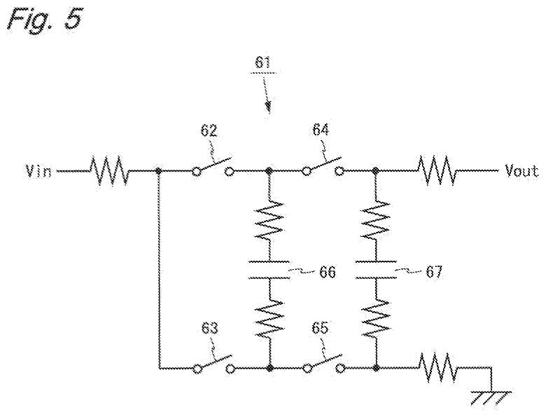

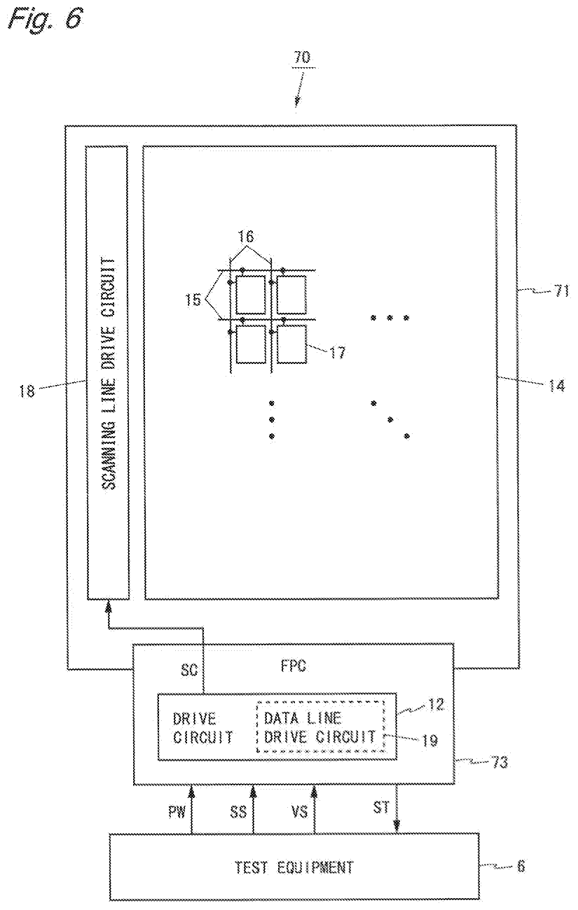

Furthermore, the power supply circuit 21 may include a charge pump circuit 61 shown in FIG. 5 in a preceding stage of the regulators 31, 32. In the charge pump circuit 61, when switches 62, 65 turn on and switches 63, 64 turn off, a capacitor 66 is charged using an input voltage Vin. When thereafter the switches 62, 65 turn off and the switches 63, 64 turn on, the capacitor 66 is further charged using the input voltage Vin. With this, an output voltage Vout becomes twice the input voltage Vin. The charge pump circuit 61 boosts the input voltage Vin twice, supplies the boosted voltage to the regulator 31, and supplies a voltage obtained by negating a polarity of the boosted voltage to the regulator 32.

When the power supply circuit 21 includes the charge pump circuit 61, the switches 62 to 65 are provided inside the drive circuit 12. In contrast, it is difficult to provide the capacitors 66, 67 inside the drive circuit 12. Thus, the capacitors 66, 67 are provided outside the drive circuit 12 (on the FPC 13 or on a board of an equipment to which the FPC 13 is connected).

The liquid crystal panel 11 and the drive circuit 12 are electrically connected using anisotropic conductive particles. The drive circuit 12 and the FPC 13 are electrically connected by a same method. In this case, a connection resistance of several ohms occurs at a connection point. Furthermore, a wiring on the liquid crystal panel 11 for connecting the switch formed inside the drive circuit 12 and the capacitor provided outside the drive circuit 12 has a wiring resistance of several ohms. The output voltage Vout of the charge pump circuit 61 is changed by an influence of the above resistance. The reference voltages VSP, VSN output, from the regulators 31, 32 may be changed by the influence of the resistance. In the liquid crystal display device 10, during testing, the output signals of the regulators 31, 32 are output to the outside of the drive circuit 12 as the state signal ST, and the state signal ST propagates to the test equipment 6 via the FPC 13. Therefore, it is possible to test whether output voltages of the regulators 31, 32 are within a desired range in a mounting state.

Although the power supply circuit 21 included in the drive circuit 12 outputs a desired voltage when the drive circuit 12 is made to operate alone, it may be impossible for the power supply circuit 21 to output the desired voltage in the mounting state because the above resistance is large. According to the liquid crystal display device 10, such defect can be detected by testing the output voltages of the regulators 31, 32 in the mounting state.

Furthermore, when the scanning line drive circuit 18 is formed on the liquid crystal panel 11 and the drive circuit 12 outputs the scanning control signal SC to the scanning line drive circuit 18, it is necessary that the power supply circuit 21 included in the drive circuit 12 generate voltages of ±15 V, for example. In this case, the high-level voltage VH and the low-level voltage VL of the scanning control signal SC are generated using the charge pump circuit. Thus, the voltage of the scanning control signal SC is also changed by the influence of the above resistance. In the liquid crystal display device 10, during testing, the scanning control signal SC is output to the outside of the drive circuit 12 as the state signal ST, and the state signal ST propagates to the test equipment 6 via the FPC 13. Therefore, it is possible to test whether the voltage of the scanning control signal SC is within a desired range in the mounting state using the test equipment 6.

Although the scanning control signal SC output from the drive circuit 12 to the scanning line drive circuit. 18 may become a desired voltage level when the drive circuit 12 is made to operate alone, it may not become the desired voltage level in the mounting state, because the above resistance or a panel load is large. According to the liquid crystal display device 10, such defect can be detected by testing a voltage level of the scanning control signal SC in the mounting state.

The drive circuit 12 includes the switches 51 to 50 for selecting a signal to be output as the state signal ST from a plurality of internal signals (see FIG. 3). According to the switch control signal, the switches 51 to 56 all turn off during normal operation and turn on selectively during testing. Therefore, the drive circuit 12 does not output the state signal ST during normal operation, and outputs the state signal ST during testing. It is desirable that the bump 59 function as an output terminal of the state signal ST during testing and function as an input terminal or an output terminal of another signal during normal operation.

The drive circuit 12 shown in FIG. 3 outputs the state signal ST from one terminal (bump 59). In place of this, the drive circuit 12 may output the state signal ST from a plurality of terminals. The less the terminals outputting the state signal ST, the less the terminals of the FPC 13.

As described above, Japanese Laid-Open Patent Publication No. 2002-365660 describes a liquid crystal display device having an additional output terminal and a test electrode pad. However, in the liquid crystal display device after mounting, a pad may be covered by resin or the like in order to protect a wiring on a liquid crystal panel, a special contact pin may be necessary in order to connect to the pad, or it may be difficult to connect to the pad because it is covered by a metal box, a touch panel, or the like. Thus, it may be impossible or difficult to apply the method described in the above document to the liquid crystal display device after mounting.

In the liquid crystal display device 10, the state signal ST output from the drive circuit 12 propagates to the test equipment 6 via the FPC 13. Therefore, an abnormality which occurs in the drive circuit 12 can be detected easily, even when it is impossible or difficult to apply the method described in the above document.

In the liquid crystal display device 10, the scanning line drive circuit 18 is formed on the liquid crystal panel 11, and the drive circuit 12 outputs the scanning control signal SC. In place of this, the drive circuit 12 may include the scanning line drive circuit 18 and may drive the scanning lines 15 of the liquid crystal panel 11. In this case, it is desirable that a signal applied to the scanning line 15 be made to propagate to the test equipment 6 via the FPC 13 as the state signal ST, as with the signal applied to the data line 16.

Ac described above, the liquid crystal display device 10 according to the present embodiment includes a display panel (liquid crystal panel 11), a connecting section (FPC 13) for electrically connecting the display panel with an external equipment (video signal source 5, test equipment 6), and the drive circuit 12 mounted on the display panel and for outputting an internal signal as the state signal ST. In the liquid crystal display device 10, the state signal ST propagates to the external equipment, via the connecting section. In this manner, in the liquid crystal display device 10, the internal signal of the drive circuit 12 mounted on the display panel is output as the state signal ST, and the state signal ST propagates to the external equipment, via the connecting section. Therefore, it is possible to easily detect the abnormality which occurs in the drive circuit with the external equipment.

Furthermore, the drive circuit 12 includes the power supply circuit 21 including the regulators 31 to 34, and outputs the output signal of the power supply circuit. 21 (output signals of the regulators 31 to 34) as the state signal ST. Therefore, it is possible to test whether the output voltage of the power supply circuit. 21 (output, voltages of the level regulators 31, 32) is within a desired range in the mounting state using the external equipment (test equipment 6).

Furthermore, the drive circuit 12 includes an output terminal (bumps 57, 58) connected to a wiring of the display panel, and outputs, as the state signal ST, the signal applied to the output terminal. When the display panel includes the data lines 16 and the drive circuit 12 includes the data line drive circuit 19 for driving the data lines 16, the drive circuit 12 outputs, as the state signal ST, the signal applied to the output terminal (bump 57) electrically connected to the data line 16. Therefore, it is possible to test whether the output voltage of the scanning control signal SC is within a desired range in the mounting state using the external equipment. Furthermore, when the display panel includes the scanning lines 15 and the scanning line drive circuit 18 drives the scanning lines 15, the drive circuit 12 outputs, as the state signal ST, the signal applied to the output terminal (bump 58) electrically connected to the scanning line drive circuit 18. Therefore, it is possible to test whether the voltage of the scanning control signal SC is within a desired range in the mounting state using the external equipment.

Furthermore, the drive circuit 12 does not output the state signal ST during normal operation, and outputs the state signal ST during testing. The drive circuit 12 includes a terminal (bump 59) for functioning as an output terminal of the state signal ST during testing and functioning as an input terminal or an output terminal of another signal during normal operation. The drive circuit 12 includes the switches 51 to 56 each selecting a signal to be output as the state signal ST from a plurality of internal signals. With this, increase of terminals of the FPC 13 can be prevented by decreasing a number of terminals for outputting the state signal ST.

### Second Embodiment

FIG. 6 is a diagram showing a connection style of a liquid crystal display device according to a second embodiment during testing. A liquid crystal display device 70 shown in FIG. 6 includes a liquid crystal panel 71, the drive circuit 12, and an FPC 73. Among elements of the present embodiment, with regard to same elements as those in the first embodiment, same reference numerals are provided arid their description is omitted. Differences from the first embodiment will be described below.

In the liquid crystal display device 70, the drive circuit 12 is mounted not on the liquid crystal panel 11 but on the FPC 73. The bump 57 of the drive circuit. 12 is electrically connected to the data line 16 via a wiring (not shown) formed on the FPC 73 and a wiring (not shown) formed on the liquid crystal panel 11. The bump 58 of the drive circuit 12 is electrically connected to the scanning line drive circuit 18 via a wiring formed on the FPC 73 and a wiring formed on the liquid crystal panel 11. The bump 59 of the drive circuit 12 is connected to a wiring formed on the FPC 73,

As describe above, in the liquid crystal display device 70 according to the present embodiment, a connecting section (FPC 73) includes a film substrate, and the drive circuit 12 is mounted on the film substrate. According to the liquid crystal display device 70 according to the present embodiment., it is possible to easily detect the abnormality which occurs in the drive circuit 12, as with the liquid crystal display device 10 according to the first embodiment.

Although a liquid crystal display device and a method for detecting a state of the liquid crystal display device capable of easily detecting an abnormality which occurs in a drive circuit have been described so far, it is possible to configure a display device other than the liquid crystal display device and a method for detecting a state of a display device other than the liquid crystal display device having similar features.

Although the present invention is described in detail in the above, the above description is exemplary in all of the aspects and is not restrictive. It is understood that various other changes and modification can be derived without going out of the present invention.

What is claimed is:

1. A display device comprising:
a display panel;
a connecting section configured to electrically connect the display panel with an external equipment; and
a drive circuit mounted on the display panel or the connecting section and configured to output an internal signal as a state signal, wherein
the state signal propagates to the external equipment via the connecting section.

2. The display device according to claim 1, wherein the drive circuit includes u power supply circuit and is configured to output an output signal of the power supply circuit as the state signal.

3. The display device according to claim 2, wherein
the power supply circuit includes a regulator, and
the drive circuit is configured to output an output signal of the regulator as the state signal.

4. The display device according to claim 1, wherein the drive circuit includes an output terminal connected to a wiring of the display panel and is configured to output, as the state signal, a signal applied to the output terminal.

5. The display device according to claim 4, wherein
the display panel includes delta lines, and
the drive circuit includes a data line drive circuit configured to drive the data lines and is configured to output, as the state signal, a signal applied to an output terminal electrically connected to the data line.

6. The display device according to claim 4, wherein
the display panel includes scanning lines and a scanning line drive circuit configured to drive the scanning lines, and
the drive circuit is configured to output, as the state signal, a signal applied to an output terminal electrically connected to the scanning line drive circuit.

7. The display device according to claim 1, wherein the drive circuit is configured not to output the state signal during normal operation, and is configured to output the state signal during testing.

8. The display device according to claim 7, wherein the drive circuit includes a terminal configured to function as an output terminal of the state signal during testing and function as an input terminal or an output terminal of another signal during normal operation.

9. The display device according to claim 1, wherein the drive circuit includes a switch configured to select a signal to be output as the state signal from a plurality of internal signals.

10. The display device according to claim 1, wherein
the connecting section includes a film substrate, and
the drive circuit is mounted on the film substrate.

11. A method for detecting a state of a display device including a display panel, a connecting section that electrically connects the display panel with an external equipment, and a drive circuit mounted on the display panel or the connecting section, the method comprising:
outputting an internal signal of the drive circuit as a state signal to an outside of the drive circuit; and
making the state signal propagate to the external equipment via the connecting section.

12. The method for detecting the state according to claim 11, wherein
the drive circuit includes a power supply circuit, and
in outputting, an output signal of the power supply circuit is output as the state signal.

13. The method for detecting the state according to claim 12, wherein
the power supply circuit includes a regulator, and
in outputting, an output signal of the regulator is output as the state signal.

14. The method for detecting the state according to claim 11, wherein
the drive circuit includes an output terminal connected to a wiring of the display panel, and
in outputting, a signal applied to the output terminal is output as the state signal.

15. The method for detecting the state according to claim 14, wherein
the display panel includes delta lines,
the drive circuit includes a data line drive circuit that drives the data lines, and
in outputting, a signal applied to an output terminal electrically connected to the data line is output as the state signal.

16. The method for detecting the state according to claim 14, wherein
the display panel includes scanning lines and a scanning line drive circuit that drives the scanning lines, and
in outputting, a signal applied to an output terminal electrically connected to the scanning line drive circuit is output as the state signal.

17. The method for detecting the state according to claim 11, wherein in outputting, the state signal is not output during normal operation, and the state signal is output, during testing.

18. The method for detecting the state according to claim 17, wherein the drive circuit includes a terminal that functions as an output terminal of the state signal during testing and functions as an input terminal or an output terminal of another signal during normal operation.

19. The method for detecting the state according to claim 11, wherein the drive circuit includes a switch that selects a signal to be output as the state signal from a plurality of internal signals.

20. The method for detecting the state according to claim 11, wherein
the connecting section includes a film substrate, and
the drive circuit is mounted on the film substrate.
